(19) United States
(12) Patent Application Publication
(10) Pub. No.: US 2025/0360446 A1
(43) Pub. Date: Nov. 27, 2025

(54) GAS-LIQUID SEPARATOR

(71) Applicants: Hyundai Motor Company, Seoul (KR); Kia Corporation, Seoul (KR)

(72) Inventor: Min Jae Kim, Hwaseong-si (KR)

(21) Appl. No.: 18/886,303

(22) Filed: Sep. 16, 2024

(30) Foreign Application Priority Data
May 21, 2024 (KR) 10-2024-0065971

(51) Int. Cl. B01D 45/14; B01D 45/02

(52) U.S. Cl. CPC B01D 45/14; B01D 45/02

(57) ABSTRACT

An embodiment gas-liquid separator includes a housing member including an air inlet port, an air discharge port, and a drain port through which droplets separated from the air are discharged, a vane rotatably disposed in the housing member and configured to generate a vortex in the air introduced into the inlet port, a droplet agglomeration guide disposed at a downstream side of the vane and coming into contact with the air having passed through the vane, wherein the droplet agglomeration guide guides agglomeration of the droplets contained in the air, and a guide member in the housing member at a downstream side of the droplet agglomeration guide, the guide member defining an air discharge flow path that guides the air, which is separated from the droplets, to the discharge port, and a droplet discharge flow path that guides the droplets separated from the air to the drain port.

### CROSS-REFERENCE TO RELATED APPLICATIONS

This application claims the benefit of Korean Patent Application No. 10-2024-0065971, filed on May 21, 2024, which application is hereby incorporated herein by reference.

### TECHNICAL FIELD

The present disclosure relates to a gas-liquid separator.

### BACKGROUND

A fuel cell vehicle (e.g., a hydrogen fuel cell vehicle) is configured to autonomously generate electricity by means of a chemical reaction between fuel (hydrogen) and air (oxygen) and travel by operating a motor.

In general, the fuel cell vehicle may include a fuel cell stack configured to generate electricity by means of an oxidation-reduction reaction between hydrogen and oxygen, a fuel supply device configured to supply fuel (hydrogen) to the fuel cell stack, an air supply device configured to supply the fuel cell stack with air (oxygen) which is an oxidant required for an electrochemical reaction, and a thermal management system (TMS) configured to discharge heat, which is generated from the fuel cell stack and power electronic parts of the vehicle, to the outside of the system and control temperatures of the fuel cell stack and the power electronic parts.

Further, discharge water (condensate water) and exhaust gas (e.g., air), which are produced during the operation of the fuel cell stack, may be discharged to the outside through an exhaust pipe.

Meanwhile, droplets may be contained in the air discharged during the operation of the fuel cell stack. In case that the air containing droplets is discharged to surrounding pedestrians or peripheral devices, the air containing droplets may cause unpleasantness to the surrounding pedestrians or corrosion of the peripheral devices.

In addition, in case that the air containing droplets is discharged onto a floor (e.g., on a road or a floor of an indoor workplace), the floor may be contaminated, and the risk of the occurrence of various types of accidents (e.g., slip and fall accidents, electric shock accidents, etc.) caused by droplets on the floor may be increased. Therefore, it is necessary to remove droplets, which are contained in the air discharged during the operation of the fuel cell stack, as much as possible.

Therefore, recently, various types of studies have been conducted to effectively remove the droplets from the air discharged during the operation of the fuel cell stack, but the study result is still insufficient. Accordingly, there is a need to develop a technology to effectively remove the droplets from the air discharged during the operation of the fuel cell stack.

### SUMMARY

The present disclosure relates to a gas-liquid separator. Particular embodiments relate to a gas-liquid separator capable of effectively capturing droplets from air discharged from a fuel cell stack.

Embodiments of the present disclosure provide a gas-liquid separator capable of improving performance in capturing droplets contained in air discharged from a fuel cell stack.

In particular, embodiments of the present disclosure can agglomerate and capture droplets while separating the droplets from air by using a centrifugal force made by vortices of the air.

Embodiments of the present disclosure can minimize a deterioration in energy efficiency caused by an increase in differential pressure of the gas-liquid separator while miniaturizing the gas-liquid separator.

Embodiments of the present disclosure can simplify a structure and improve a degree of design freedom and spatial utilization.

Embodiments of the present disclosure can minimize a degree to which droplets and air are mixed again and improve efficiency in separating droplets.

The features achievable by the embodiments are not limited to the above-mentioned features, but they also include objects or effects that may be understood from the solutions or embodiments described below.

An exemplary embodiment of the present disclosure provides a gas-liquid separator including a housing member having an inlet port through which air is introduced, a discharge port through which the air is discharged, and a drain port through which droplets separated from the air are discharged, a vane rotatably provided in the housing member and configured to generate a vortex in the air introduced into the inlet port, a droplet agglomeration guide provided at a downstream side of the vane and configured to come into contact with the air having passed through the vane, the droplet agglomeration guide being configured to guide the agglomeration of the droplets contained in the air, and a guide member provided in the housing member and positioned at a downstream side of the droplet agglomeration guide, the guide member being configured to define an air discharge flow path configured to guide the air, which is separated from the droplets, to the discharge port, and a droplet discharge flow path configured to guide the droplets to the drain port.

This is to effectively capture droplets contained in air discharged from a fuel cell stack.

That is, droplets may be contained in the air discharged during the operation of the fuel cell stack. In case that the air containing droplets is discharged to surrounding pedestrians or peripheral devices, the air containing droplets may cause unpleasantness to the surrounding pedestrians or corrosion of the peripheral devices. In addition, in case that the air containing droplets is discharged onto a floor (e.g., on a road or a floor of an indoor workplace), the floor may be contaminated, and the risk of the occurrence of various types of accidents (e.g., slip and fall accidents, electric shock accidents, etc.) caused by droplets on the floor may be increased. Therefore, it is necessary to remove droplets, which are contained in the air discharged during the operation of the fuel cell stack, as much as possible.

In contrast, in the embodiments of the present disclosure, the vane is used to forcibly generate vortices in the air, and the droplets contained in the air are agglomerated while the air having passed through the vane passes through (comes into contact with) the droplet agglomeration guide. Therefore, it is possible to obtain an advantageous effect of improving the performance and efficiency in capturing the droplets. Moreover, it is possible to minimize the number of droplets contained in the air discharged from the fuel cell stack. Therefore, it is possible to obtain an advantageous effect of inhibiting contamination caused by the droplets and reducing risks of the occurrence of accidents (e.g., a slip-and-fall accident, an electric shock accident, etc.).

Among other things, in the embodiments of the present disclosure, the droplets, which cannot be separated by the vortex, are agglomerated while passing through (coming into contact with) the droplet agglomeration guide, such that it is possible to effectively capture the droplets contained in the air discharged from the fuel cell stack and to effectively discharge the air without increasing the size of the gas-liquid separator and the number of gas-liquid separators. Therefore, it is possible to obtain an advantageous effect of simplifying the discharge route for air, contributing to miniaturizing the fuel cell system, and improving the degree of design freedom and spatial utilization.

The housing member may have various structures having the inlet port, the discharge port, and the drain port.

According to an exemplary embodiment of the present disclosure, the housing member may include a first housing having the inlet port and a second housing having the discharge port and the drain port and configured such that the first housing and the second housing collectively surround a periphery of the guide member.

The first housing may have various structures having the inlet port.

According to an exemplary embodiment of the present disclosure, the first housing may include an inlet portion having the inlet port and provided to have a first cross-sectional area and an enlarged portion connected to a downstream side of the inlet portion and provided to have a second cross-sectional area larger than the first cross-sectional area.

According to an exemplary embodiment of the present disclosure, the enlarged portion may be provided to have a cross-sectional area that gradually increases from one end, which is adjacent to the inlet portion, toward the other end.

As described above, the first housing has a cross-sectional area that gradually increases from an inlet (inlet port) toward an outlet, such that the pressure of the air passing through the first housing may increase. Therefore, it is possible to obtain an advantageous effect of minimizing an increase in differential pressure of the gas-liquid separator.

According to an exemplary embodiment of the present disclosure, the inlet portion may be defined to have a straight length of one or more times an outer diameter of the vane, and the enlarged portion is defined to have a diameter smaller than 2.5 times the outer diameter of the vane.

This is based on the fact that the vortex (or swirl) generated by the vane cannot be stably maintained in case that the inlet portion has a straight length of one or less times the outer diameter of the vane. According to an embodiment of the present disclosure, because the inlet portion has a straight length of one or more times the outer diameter of the vane, it is possible to obtain an advantageous effect of stabilizing the vortex (or swirl) generated by the vane.

In addition, this is based on the fact that a differential pressure decreases as a cross-sectional area (e.g., a diameter) of the enlarged portion increases, but the intensity of the vortex decreases, and the efficiency in separating the droplets from the air deteriorates as the cross-sectional area of the enlarged portion increases. In an embodiment of the present disclosure, because the enlarged portion has a diameter smaller than 2.5 times the outer diameter of the vane, it is possible to obtain an advantageous effect of stably maintaining the intensity and flow of the vortex.

According to an exemplary embodiment of the present disclosure, the gas-liquid separator may include a filter member provided in the guide member and configured to surround a periphery of the air discharge flow path, the filter member being configured to capture the droplets.

The second housing may have various structures having the discharge port and the drain port.

According to an exemplary embodiment of the present disclosure, the first housing may include an outer housing part and an inner housing part provided in the outer housing part approximately coaxially with the outer housing part and spaced apart from an inner peripheral surface of the outer housing part, the inner housing part being configured to support the filter member.

The inner housing part may be configured to have various structures capable of supporting the filter member.

According to an exemplary embodiment of the present disclosure, the inner housing part may include an inner frame member having one end supported on the outer housing part and an outer frame member having one end supported on the outer housing part, the outer frame member being configured to surround a periphery of the inner frame member, and the filter member may be accommodated between the inner frame member and the outer frame member.

According to an exemplary embodiment of the present disclosure, the gas-liquid separator may include a first through portion which is provided in the inner frame member and in which the droplet falls downward in a gravitational direction and a second through portion which is provided in the outer frame member and communicates with the first through portion and in which the droplet falls downward in the gravitational direction.

According to an exemplary embodiment of the present disclosure, the gas-liquid separator may include a first droplet guide groove configured to communicate with the droplet discharge flow path and provided in a bottom portion of the first housing in the longitudinal direction of the housing and a second droplet guide groove provided in a bottom portion of the second housing in the longitudinal direction of the housing so that one end communicates with the first droplet guide groove and the other end communicates with the drain port.

As described above, in an embodiment of the present disclosure, the first droplet guide groove and the second droplet guide groove are provided in the bottom portion of the first housing and the bottom portion of the second housing, such that the droplets separated from the air by the vortex (the droplets captured on the inner peripheral surface of the housing member by the centrifugal force made by the vortex) may move along the inner peripheral surface of the housing member and be captured in the first droplet guide groove and the second droplet guide groove. Therefore, it is possible to obtain an advantageous effect of minimizing a degree to which the droplets and the air are introduced into the guide member.

According to an exemplary embodiment of the present disclosure, the first droplet guide groove may be provided to be spaced apart from the vane at a distance of one or more times the outer diameter of the vane in the longitudinal direction of the housing member.

Because the first droplet guide groove is spaced apart from the vane at a distance of one or more times the outer diameter of the vane as described above, the droplets may be captured in the first droplet guide groove after the vortex is stably generated by the vane. Therefore, it is possible to obtain an advantageous effect of improving the efficiency in capturing the droplets.

According to an exemplary embodiment of the present disclosure, the gas-liquid separator may include a valve seating part provided at an end of the second housing and configured to communicate with an outlet of the discharge port, and the valve seating part may be inclined at a preset reference angle with respect to a vertical line.

This is based on the fact that a valve mounted on the valve seating part to selectively open or close the discharge port may be frozen in the winter season. In an embodiment of the present disclosure, the valve seating part is provided to be inclined at the reference angle, such that the valve mounted on the discharge port may be disposed to be inclined. Therefore, it is possible to obtain an advantageous effect of inhibiting the valve from being frozen in the winter season.

The vane may have various structures capable of generating vortices in the air introduced into the inlet port.

According to an exemplary embodiment of the present disclosure, the vane may include a vane frame provided in the inlet port, inner blades provided in the vane frame in a circumferential direction of the vane frame, and outer blades continuously connected to the inner blades and protruding from one end of the vane frame that faces the droplet agglomeration guide.

As described above, in an embodiment of the present disclosure, the inner blades, which are disposed in the vane frame, and the outer blades, which protrude to the outside of the vane frame, may rotate together and generate the vortices in the air introduced into the inlet port, such that stronger vortices may be generated in the air introduced into the inlet port. In particular, in an embodiment of the present disclosure, the outer blades protrude from one end of the vane frame (the end of the downstream side of the vane frame), such that stronger vortices may be generated in the air introduced into the inlet port without increasing the size of the vane.

The droplet agglomeration guide may have various structures capable of guiding the agglomeration of the droplets contained in the air while coming into contact with the air having passed through the vane.

According to an exemplary embodiment of the present disclosure, the droplet agglomeration guide may be provided to have a cross-sectional area that gradually increases from one end, which is adjacent to the vane, toward the other end, and an inclined guide portion may be defined on a peripheral surface of the droplet agglomeration guide and guide the droplets toward an inner peripheral surface of the housing member.

According to an exemplary embodiment of the present disclosure, the gas-liquid separator may include a recessed portion recessed in the droplet agglomeration guide and positioned at a downstream side of the inclined guide portion.

As described above, the recessed portion with an empty space shape is provided at the downstream side of the inclined guide portion, such that the pressure of the air passing through the recessed portion (passing between the droplet agglomeration guide and the guide member) may increase. Therefore, it is possible to obtain an advantageous effect of minimizing an increase in differential pressure of the gas-liquid separator.

According to an exemplary embodiment of the present disclosure, the gas-liquid separator may include a stepped portion provided on the peripheral surface of the droplet agglomeration guide.

As described above, in an embodiment of the present disclosure, the stepped portions are provided on the peripheral surface of the droplet agglomeration guide, such that a contact area of the droplet agglomeration guide with which the droplets come into contact may be increased, and the time for which the droplets stay on the peripheral surface of the droplet agglomeration guide may be increased. Therefore, it is possible to obtain an advantageous effect of improving the efficiency in agglomerating the droplets.

The guide member may have various structures capable of defining the air discharge flow path and the droplet discharge flow path.

According to an exemplary embodiment of the present disclosure, the guide member may include a body portion configured to separate the air discharge flow path and the droplet discharge flow path and an air guide portion provided in the body portion and configured to guide the air, which is separated from the droplets in the droplet discharge flow path, to the air discharge flow path.

The air guide portion may have various structures capable of guiding the air, which is introduced into the droplet discharge flow path, to the air discharge flow path.

According to an exemplary embodiment of the present disclosure, the body portion may be provided by spirally winding base members so that the base members partially overlap one another, and the air guide portion is defined along a gap between the adjacent base members.

As described above, in an embodiment of the present disclosure, the base members are wound in a spiral shape, such that a separate process (e.g., a machining process) for forming the air guide portions does not need to be performed. Therefore, it is possible to obtain an advantageous effect of simplifying the structure of the body portion, simplifying the process of manufacturing the body portion, and reducing costs.

According to an exemplary embodiment of the present disclosure, the air guide portion may be defined to have an inlet in a direction opposite to a movement direction of the air from the vane toward the guide member.

This is based on the fact that when the air moves in the direction from the vane toward the guide member, the droplets contained in the air also move in the direction from the vane toward the guide member. Because the inlets of the air guide portions are provided in the direction opposite to the movement direction of the air, the droplets may remain in the droplet discharge flow path, and only the air, which is lighter in weight than the droplets, may be introduced into the air guide portions while changing the direction. Therefore, it is possible to obtain an advantageous effect of minimizing a degree to which the droplets are introduced into the air discharge flow path through the air guide portions.

According to an exemplary embodiment of the present disclosure, the air guide portion may be defined to have an inlet in a direction opposite to a rotation direction of the air corresponding to a circumferential direction of the housing member.

This is based on the fact that when the air is rotated in the preset rotation direction by the vane, the droplets contained in the air are also rotated in the preset rotation direction. Because the inlets of the air guide portions are provided in the direction opposite to the rotation direction of the air, the droplets may remain in the droplet discharge flow path, and only the air, which is lighter in weight than the droplets, may be introduced into the air guide portion while changing the direction. Therefore, it is possible to obtain an advantageous effect of minimizing a degree to which the droplets are introduced into the air discharge flow path through the air guide portion.

### BRIEF DESCRIPTION OF THE DRAWINGS

FIG. 1 is a view for explaining a gas-liquid separator according to an embodiment of the present disclosure.

FIG. 2 is a view for explaining flows of air and droplets in the gas-liquid separator according to an embodiment of the present disclosure.

FIGS. 3 and 4 are views for explaining a first housing of the gas-liquid separator according to an embodiment of the present disclosure.

FIGS. 5 and 6 are views for explaining a second housing of the gas-liquid separator according to an embodiment of the present disclosure.

FIGS. 7 and 8 are views for explaining a vane of the gas-liquid separator according to an embodiment of the present disclosure.

FIG. 9 is a view for explaining a droplet agglomeration guide of the gas-liquid separator according to an embodiment of the present disclosure.

FIG. 10 is a view for explaining a modified example of the droplet agglomeration guide of the gas-liquid separator according to an embodiment of the present disclosure.

FIG. 11 is a view for explaining a guide member of the gas-liquid separator according to an embodiment of the present disclosure.

FIG. 12 is a view for explaining a modified example of the guide member of the gas-liquid separator according to an embodiment of the present disclosure.

### DETAILED DESCRIPTION OF ILLUSTRATIVE EMBODIMENTS

Hereinafter, exemplary embodiments of the present disclosure will be described in detail with reference to the accompanying drawings.

However, the technical spirit of the present disclosure is not limited to those embodiments described herein but may be implemented in various different forms. One or more of the constituent elements in the embodiments may be selectively combined and substituted for use within the scope of the technical spirit of the present disclosure.

In addition, unless otherwise specifically and explicitly defined and stated, the terms (including technical and scientific terms) used in the embodiments of the present disclosure may be construed as having the meaning which may be commonly understood by a person of ordinary skill in the art to which the present disclosure pertains. The meanings of the commonly used terms such as the terms defined in dictionaries may be interpreted in consideration of the contextual meanings of the related technology.

In addition, the terms used in the embodiments of the present disclosure are for explaining the embodiments, not for limiting the present disclosure.

In the present specification, unless particularly stated otherwise, a singular form may also include a plural form. The expression “at least one (or one or more) of A, B, and C” may include one or more of all combinations that can be made by combining A, B, and C.

In addition, the terms such as first, second, A, B, (a), and (b) may be used to describe constituent elements of the embodiments of the present disclosure.

These terms are used only for the purpose of discriminating one constituent element from another constituent element, and the nature, the sequences, or the orders of the constituent elements are not limited by the terms.

Further, when one constituent element is described as being ‘connected,’ ‘coupled,’ or ‘attached’ to another constituent element, one constituent element may be connected, coupled, or attached directly to another constituent element or connected, coupled, or attached to another constituent element through still another constituent element interposed therebetween.

In addition, the expression “one constituent element is provided or disposed above (on) or below (under) another constituent element” includes not only a case in which the two constituent elements are in direct contact with each other, but also a case in which one or more other constituent elements are provided or disposed between the two constituent elements. The expression “above (on) or below (under)” may mean a downward direction as well as an upward direction based on one constituent element.

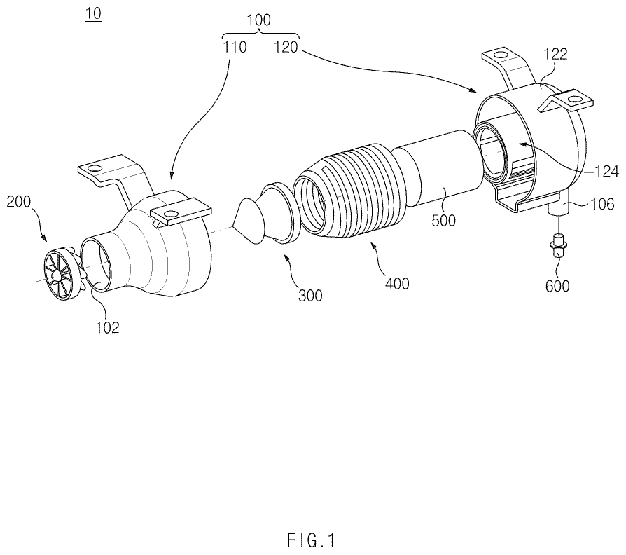

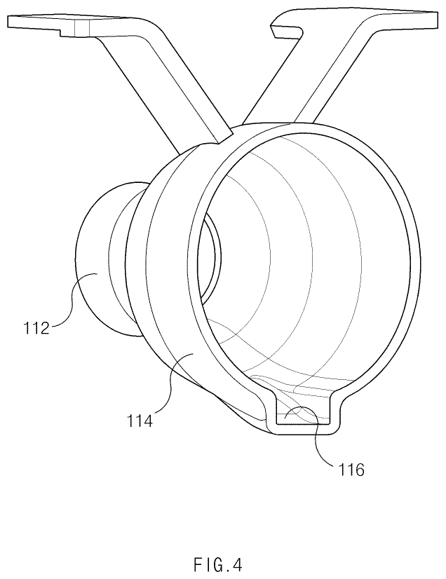

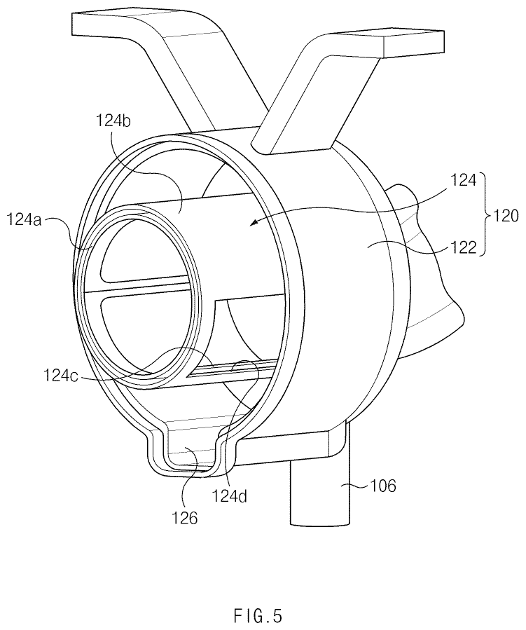

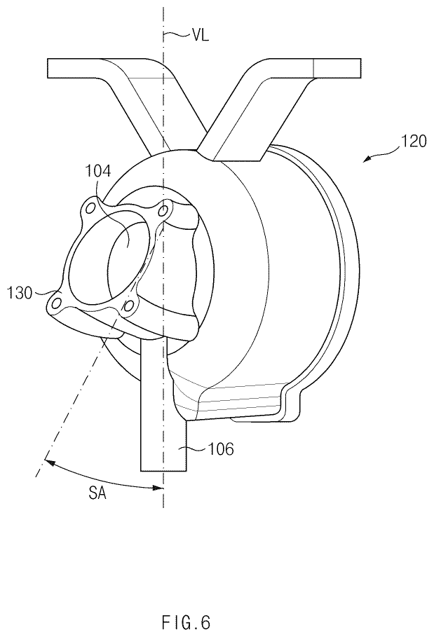

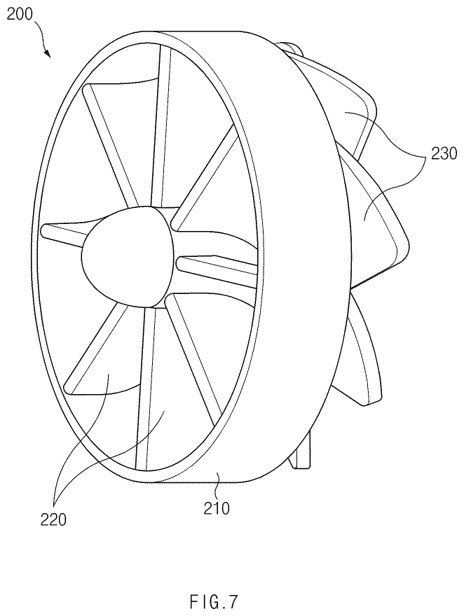

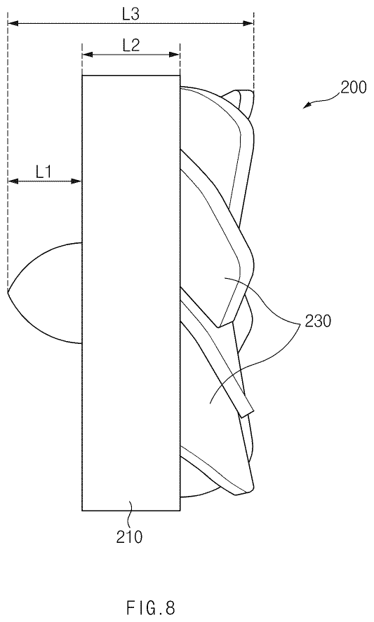

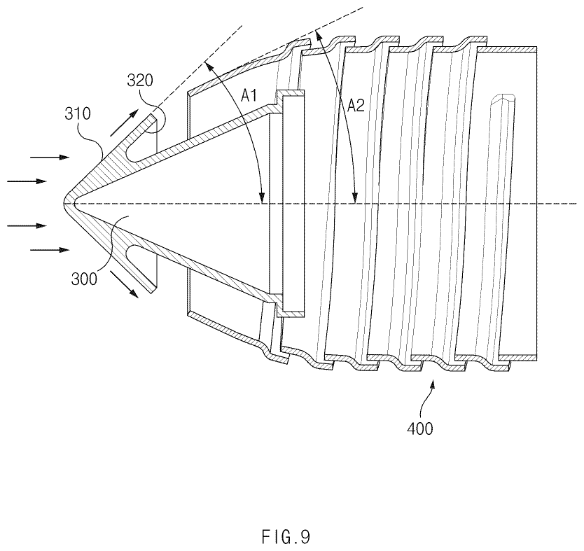

With reference to FIGS. 1 to 12, a gas-liquid separator 10 according to an embodiment of the present disclosure includes a housing member 100 having an inlet port 102 through which air is introduced, a discharge port 104 through which air is discharged, and a drain port 106 through which droplets separated from the air are discharged, a vane 200 rotatably provided in the housing member 100 and configured to generate vortices of the air introduced into the inlet port 102, a droplet agglomeration guide 300 provided at a downstream side of the vane 200 and configured to come into contact with the air having passed through the vane 200, the droplet agglomeration guide 300 being configured to guide the agglomeration of the droplets contained in the air, and a guide member 400 provided in the housing member 100 and positioned at a downstream side of the droplet agglomeration guide 300, the guide member 400 being configured to define an air discharge flow path 402 configured to guide air, which is separated from droplets, to the discharge port 104, and a droplet discharge flow path 404 configured to guide the droplets to the drain port 106.

For reference, the gas-liquid separator 10 according to an embodiment of the present disclosure may be used to capture droplets from air discharged from an object. The present disclosure is not restricted or limited by the type and properties of the object to which the gas-liquid separator 10 is applied.

Hereinafter, an example will be described in which the gas-liquid separator 10 according to an embodiment of the present disclosure is applied to capture droplets from air discharged from a fuel cell stack (not illustrated) applied to mobility vehicles such as automobiles, ships, and airplanes.

The fuel cell stack refers to a kind of power generation device that generates electrical energy through a chemical reaction of fuel (e.g., hydrogen), and the fuel cell stack may be configured by stacking several tens or hundreds of fuel cells (unit cells) in series.

The fuel cell may have various structures capable of producing electricity by means of an oxidation-reduction reaction between fuel (e.g., hydrogen) and an oxidant (e.g., air).

For example, the fuel cell may include a membrane electrode assembly (MEA) (not illustrated) having catalyst electrode layers in which electrochemical reactions occur and which are attached to two opposite sides of an electrolyte membrane through which hydrogen ions move, a gas diffusion layer (GDL) (not illustrated) configured to uniformly distribute reactant gases and transfer generated electrical energy, a gasket (not illustrated) and a fastener (not illustrated) configured to maintain leakproof sealability for the reactant gases and a coolant and maintain an appropriate fastening pressure, and a separator (bipolar plate) (not illustrated) configured to move the reactant gases and the coolant.

More specifically, in the fuel cell, hydrogen, which is fuel, and air (oxygen), which is an oxidant, are supplied to an anode and a cathode of the membrane electrode assembly, respectively, through flow paths in the separator, such that the hydrogen is supplied to the anode, and the air is supplied to the cathode.

The hydrogen supplied to the anode is decomposed into hydrogen ions (protons) and electrons by catalysts in the electrode layers provided at two opposite sides of the electrolyte membrane. Only the hydrogen ions are selectively transmitted to the cathode through the electrolyte membrane, which is a cation exchange membrane, and at the same time, the electrons are transmitted to the cathode through the gas diffusion layer and the separator which are conductors.

At the cathode, the hydrogen ions supplied through the electrolyte membrane and the electrons transmitted through the separator meet oxygen in the air supplied to the cathode by an air supply device, thereby creating a reaction of producing water. As a result of the movement of the hydrogen ions, the electrons flow through external conductive wires, and the electric current is generated as a result of the flow of the electrons.

With reference to FIGS. 1 to 6, the housing member 100 includes the inlet port 102 through which the air discharged from the fuel cell stack is introduced, the discharge port 104 through which the air is discharged, and the drain port 106 through which the droplets separated from the air are discharged.

Hereinafter, an example will be described in which the air discharged from the fuel cell stack is supplied to the inlet port 102 of the housing member 100 while passing through a humidifier (e.g., a humidifier configured to humidify air, which is to be supplied to the fuel cell stack, by using moist air discharged from the fuel cell stack) (not illustrated). According to another embodiment of the present disclosure, the air discharged from the fuel cell stack may be immediately supplied to the inlet port of the housing member without passing through the humidifier.

The housing member 100 may have various structures having the inlet port 102, the discharge port 104, and the drain port 106. The present disclosure is not restricted or limited by the structure of the housing member 100.

According to an exemplary embodiment of the present disclosure, the housing member 100 may include a first housing 110 having the inlet port 102 and a second housing 120 having the discharge port 104 and the drain port 106 and configured such that the first housing 110 and the second housing 120 collectively surround a periphery of the guide member 400.

In the embodiment of the present disclosure illustrated and described above, the example has been described in which the housing member 100 includes the first housing 110 and the second housing 120. However, according to another embodiment of the present disclosure, the housing member may include three or more housings.

Hereinafter, an example will be described in which the inlet port 102 is provided at a first end (a left end based on FIG. 1) of the housing member 100 based on a longitudinal direction, the discharge port 104 is provided at a second end (a right end based on FIG. 1) of the housing member 100 based on the longitudinal direction, and the drain port 106 is provided in a lower portion of the housing member 100 adjacent to the second end of the housing member 100.

The first housing 110 may have various structures having the inlet port 102. The present disclosure is not restricted or limited by the structure and shape of the first housing 110.

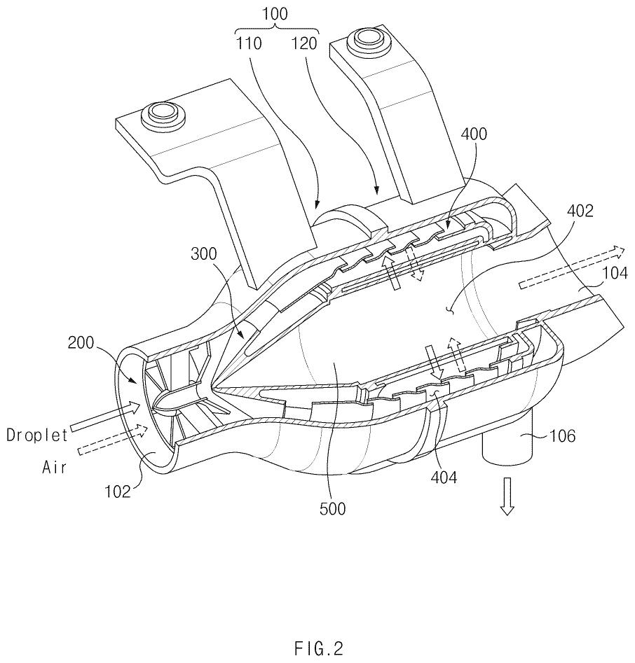

With reference to FIGS. 2 to 4, the first housing 110 according to an exemplary embodiment of the present disclosure may include an inlet portion 112, having the inlet port 102 and provided to have a first cross-sectional area, and an enlarged portion 114 connected to a downstream side of the inlet portion 112 and provided to have a second cross-sectional area larger than the first cross-sectional area.

For example, the inlet portion 112 may have a straight pipe shape having the first cross-sectional area. The inlet port 102 having a circular cross-section may be defined along the inside of the inlet portion 112. Hereinafter, an example will be described in which the vane 200 is accommodated in the inlet port 102.

The enlarged portion 114 may have various structures having the second cross-sectional area larger than the first cross-sectional area. The present disclosure is not restricted or limited by the structure and shape of the second housing 120.

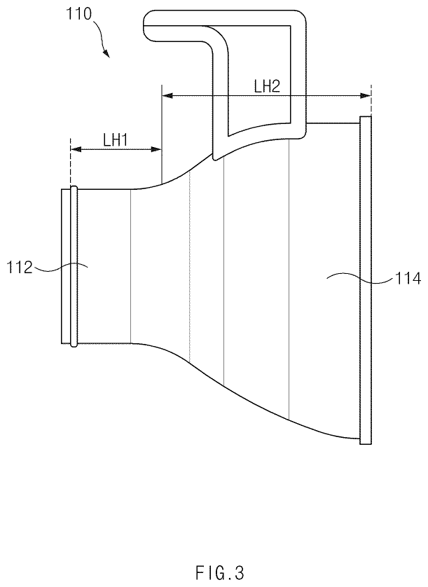

According to an exemplary embodiment of the present disclosure, the enlarged portion 114 may be provided to have a cross-sectional area that gradually increases from a first end (a left end based on FIG. 3), which is adjacent to the inlet portion 112, toward a second end (a right end based on FIG. 3).

Hereinafter, an example will be described in which the enlarged portion 114 is configured to have an approximately truncated conical shape (circular truncated conical shape) having a circular cross-section gradually enlarged from one end toward the other end.

As described above, the first housing 110 has a cross-sectional area that gradually increases from an inlet (inlet port) toward an outlet, such that the pressure of the air passing through the first housing 110 may increase. Therefore, it is possible to obtain an advantageous effect of minimizing an increase in differential pressure of the gas-liquid separator 10.

According to the exemplary embodiment of the present disclosure, the inlet portion 112 may be defined to have a straight length of one or more times an outer diameter of the vane 200. In particular, the inlet portion 112 may be configured to have a straight length of two or more times the outer diameter of the vane 200.

This is based on the fact that the vortex (or swirl) generated by the vane 200 cannot be stably maintained in case that the inlet portion 112 has a straight length of one or less times the outer diameter of the vane 200. According to an embodiment of the present disclosure, because the inlet portion 112 has a straight length of one or more times the outer diameter of the vane 200, it is possible to obtain an advantageous effect of stabilizing the vortex (or swirl) generated by the vane 200.

In addition, the enlarged portion 114 may be defined to have a diameter smaller than a diameter of 2.5 times the outer diameter of the vane 200.

This is based on the fact that a differential pressure decreases as a cross-sectional area (e.g., a diameter) of the enlarged portion 114 increases, but the intensity of the vortex decreases, and the efficiency in separating the droplets from the air deteriorates as the cross-sectional area of the enlarged portion 114 increases. In an embodiment of the present disclosure, because the enlarged portion 114 has a diameter smaller than 2.5 times the outer diameter of the vane 200, it is possible to obtain an advantageous effect of stably maintaining the intensity and flow of the vortex.

According to an exemplary embodiment of the present disclosure, the gas-liquid separator 10 may include a filter member 500 provided in the guide member 400 while surrounding a periphery of the air discharge flow path 402 and configured to capture the droplets. The air passing through the guide member 400 may pass through the filter member 500 and be discharged to the discharge port 104 along the air discharge flow path 402.

The filter member 500 may have various structures capable of capturing the droplets contained in the air. The present disclosure is not restricted or limited by the structure and shape of the filter member 500.

For example, a thin-film type mesh member (e.g., a wire mesh) having a plurality of mesh holes may be used as the filter member 500. In particular, the filter member 500 may be provided to have an approximately cylindrical hollow shape.

According to another embodiment of the present disclosure, the filter member may have a structure such as a porous structure, metal foam, fins, spiral structures, or iron scouring pads.

The second housing 120 may have various structures having the discharge port 104 and the drain port 106. The present disclosure is not restricted or limited by the structure and shape of the second housing 120.

With reference to FIGS. 2, 5, and 6, according to an exemplary embodiment of the present disclosure, the first housing 110 may include an outer housing part 122 and an inner housing part 124 spaced apart from an inner peripheral surface of the outer housing part 122 and provided in the outer housing part 122 approximately coaxially with the outer housing part 122, the inner housing part 124 being configured to support the filter member 500.

The outer housing part 122 may have various structures capable of surrounding the periphery of the guide member 400 collectively with the first housing 110. The present disclosure is not restricted or limited by the structure and shape of the outer housing part 122.

For example, the outer housing part 122 may have an approximately cylindrical hollow shape. The discharge port 104 may be provided at the end of the outer housing part 122 based on the longitudinal direction, and the drain port 106 may be provided in a lower portion of the outer housing part 122 in an approximately vertical direction.

The drain port 106 may be variously changed in size in accordance with required conditions and design specifications. The present disclosure is not restricted or limited by the size of the drain port 106.

According to an exemplary embodiment of the present disclosure, the drain port 106 may be configured to have a diameter of 10 pi (10 mm) or more. Because the drain port 106 has a diameter of 10 pi or more as described above, it is possible to obtain an advantageous effect of ensuring a stable discharge of the droplets.

Meanwhile, in case that an operating pressure of the gas-liquid separator 10 increases, the diameter of the drain port 106 may decrease to minimize a flow loss. However, the drain port 106 may be configured to have a diameter of 5 pi or more to minimize a degree to which the drain port 106 is frozen.

The inner housing part 124 may be configured to have various structures capable of supporting the filter member 500. The present disclosure is not restricted or limited by the structure and shape of the inner housing part 124.

According to an exemplary embodiment of the present disclosure, the inner housing part 124 may include an inner frame member 124a having one end supported on an inner surface of the outer housing part 122 and an outer frame member 124b provided to surround a periphery of the inner frame member 124a and having one end supported on the inner surface of the outer housing part 122. The filter member 500 may be interposed (accommodated) between the inner frame member 124a and the outer frame member 124b.

For example, the inner frame member 124a may have an approximately cylindrical hollow shape, and the outer frame member 124b may have an approximately cylindrical hollow shape having a larger diameter than the inner frame member 124a.

According to an exemplary embodiment of the present disclosure, the gas-liquid separator 10 may include a first through portion 124c provided in the inner frame member 124a so that the droplets fall downward in the gravitational direction and a second through portion 124d provided in the outer frame member 124b and configured to communicate with the first through portion 124c so that the droplets fall downward in the gravitational direction.

The first through portion 124c and the second through portion 124d may each have various structures in which the droplets agglomerated in the filter member 500 or the droplets introduced into the air discharge flow path 402 may fall downward in the gravitational direction. The present disclosure is not restricted or limited by the structures and shapes of the first through portion 124c and the second through portion 124d.

In particular, the inner frame member 124a and the outer frame member 124b may be provided to cover an upper section of the filter member 500 (an upper section of a horizontal line based on the horizontal line passing through a center of the inner frame member 124a and a center of the outer frame member 124b). The first through portion 124c and the second through portion 124d may be provided to correspond to a lower section of the filter member 500 (a lower section of the horizontal line based on the horizontal line passing through the center of the inner frame member 124a and the center of the outer frame member 124b).

Because the first through portion 124c and the second through portion 124d are provided only in the lower section of the inner frame member 124a and the lower section of the outer frame member 124b as described above, the droplets may flow downward along the outer peripheral surface of the outer frame member 124b and be discharged to the drain port 106 even though the droplets agglomerated on the upper portion of the outer frame member 124b (e.g., the droplets agglomerated on the inner peripheral surface of the second housing) fall onto the outer frame member 124b. In contrast, the droplets agglomerated in the filter member 500 or the droplets introduced into the air discharge flow path 402 may fall along the first through portion 124c and the second through portion 124d and be discharged through the drain port 106.

According to an exemplary embodiment of the present disclosure, the gas-liquid separator 10 may include a first droplet guide groove 116 provided in a bottom portion (a bottom portion of the inner peripheral surface) of the first housing 110 in the longitudinal direction of the housing member 100 and a second droplet guide groove 126 provided in a bottom portion (a bottom portion of the inner peripheral surface) of the second housing 120 in the longitudinal direction of the housing member 100 so that one end thereof communicates with the first droplet guide groove 116 and the other end thereof communicates with the drain port 106.

For example, the first droplet guide groove 116 may be provided in the bottom portion of the first housing 110 and may have a straight shape having an approximately quadrangular cross-section in the longitudinal direction of the housing member 100, and the second droplet guide groove 126 may be provided in the bottom portion of the second housing 120 and may have a straight shape having an approximately quadrangular cross-section.

As described above, in an embodiment of the present disclosure, the first droplet guide groove 116 and the second droplet guide groove 126 are provided in the bottom portion of the first housing 110 and the bottom portion of the second housing 120, such that the droplets separated from the air by the vortex (the droplets captured on the inner peripheral surface of the housing member 100 by the centrifugal force made by the vortex) may move along the inner peripheral surface of the housing member 100 and be captured in the first droplet guide groove 116 and the second droplet guide groove 126. Therefore, it is possible to obtain an advantageous effect of minimizing a degree to which the droplets and the air are introduced into the guide member 400.

In an embodiment of the present disclosure illustrated and described above, the example has been described in which the first droplet guide groove 116 and the second droplet guide groove 126 each have a straight shape. However, according to another embodiment of the present disclosure, the first droplet guide groove and the second droplet guide groove may each have a curved shape or other shapes.

According to an exemplary embodiment of the present disclosure, the first droplet guide groove 116 may be provided to be spaced apart from the vane 200 at a distance of one or more times the outer diameter of the vane 200 in the longitudinal direction of the housing member 100.

Because the first droplet guide groove 116 is spaced apart from the vane 200 at a distance of one or more times the outer diameter of the vane 200 as described above, the droplets may be captured in the first droplet guide groove 116 after the vortex is stably generated by the vane 200. Therefore, it is possible to obtain an advantageous effect of improving the efficiency in capturing the droplets.

In particular, the first droplet guide groove 116 and the second droplet guide groove 126 may collectively define a water storage capacity of 0.2 L or more. Because the first droplet guide groove 116 and the second droplet guide groove 126 define the water storage capacity of 0.2 L or more as described above, the droplets, which cannot be discharged to the drain port 106 in case that the discharge amount of droplets rapidly increases, may be temporarily stored in the first droplet guide groove 116 and the second droplet guide groove 126. Therefore, it is possible to obtain an advantageous effect of minimizing a degree to which the droplets separated from the air overflows to the air discharge flow path 402 (the discharge port).

According to an exemplary embodiment of the present disclosure, the gas-liquid separator 10 may include a valve seating part 130 provided at an end of the second housing 120 and configured to communicate with an outlet of the discharge port 104, and the valve seating part 130 may be inclined at a preset reference angle SA with respect to a vertical line VL.

This is based on the fact that a valve (not illustrated) mounted on the valve seating part 130 to selectively open or close the discharge port 104 may be frozen in the winter season. In an embodiment of the present disclosure, the valve seating part 130 is provided to be inclined at the reference angle SA, such that the valve mounted on the discharge port 104 may be disposed to be inclined. Therefore, it is possible to obtain an advantageous effect of inhibiting the valve from being frozen in the winter season.

The reference angle SA may be variously changed in accordance with required conditions and design specifications. The present disclosure is not restricted or limited by the range of the reference angle. For example, the reference angle SA may be defined to be inclined at 10 degrees or more with respect to the vertical line VL. In particular, the reference angle SA may be defined to be inclined at a 20 degrees or more with respect to the vertical line VL.

The vane 200 is rotatably provided in the housing member 100 to forcibly generate vortices in the air introduced into the inlet port 102.

That is, in an embodiment of the present disclosure, the vortex having a swirling shape is generated in the air, which is introduced into the inlet port 102, using the vane 200, such that the droplets contained in the air may be pushed, by a difference in specific gravity and a centrifugal force made by the vortex of the air, toward the edge of the housing member 100 (the inner peripheral surface of the housing member 100) from an approximate central portion of the housing member 100 in a radial direction of the housing member 100, and the droplets pushed toward the edge of the housing member 100 may be captured by being brought into contact with the inner surface of the housing member 100.

The vane 200 may have various structures capable of generating the vortex in the air introduced into the inlet port 102. The present disclosure is not restricted or limited by the type and structure of the vane 200.

According to an exemplary embodiment of the present disclosure, the vane 200 may include a vane frame 210 provided in the inlet port 102, inner blades 220 provided in the vane frame 210 in a circumferential direction of the vane frame 210, and outer blades 230 continuously connected to the inner blades 220 and protruding from one end of the vane frame 210 that faces the droplet agglomeration guide 300.

For example, the vane frame 210 may have an approximate ring shape having an outer diameter corresponding to an inner diameter of the inlet port 102, the inner blades 220 may be disposed radially based on a rotation center of the vane frame 210, and the outer blades 230 may be continuously connected to the ends of the inner blades 220, bent at predetermined curvatures, and protruding to the outside of the vane frame 210.

In particular, a total length L3 of the vane 200 in an axial direction may be defined to be larger than ½ of a length L2 of the vane frame 210 (a length of the vane frame in the axial direction of the vane) (L3>L2/2). A length L1 of an introduction portion of the vane 200 (an introduction portion protruding from a tip portion of the vane frame) may be defined to be smaller than ½ of the length L2 of the vane frame 210 (the length of the vane frame in the axial direction of the vane).

As described above, in the embodiment of the present disclosure, the inner blades 220, which are disposed in the vane frame 210, and the outer blades 230, which protrude to the outside of the vane frame 210, may rotate together and generate the vortices in the air introduced into the inlet port 102, such that stronger vortices may be generated in the air introduced into the inlet port 102. In particular, in an embodiment of the present disclosure, the outer blades 230 protrude from one end of the vane frame 210 (the end of the downstream side of the vane frame 210), such that stronger vortices may be generated in the air introduced into the inlet port 102 without increasing the size of the vane 200.

With reference to FIGS. 1, 2, and 9, the droplet agglomeration guide 300 is provided at the downstream side of the vane 200 and configured to come into contact with the air having passed through the vane 200 in order to guide the agglomeration of the droplets contained in the air.

This is based on the fact that the droplets with relatively small sizes (specific gravity) flow along an approximately central portion of the vortex without being separated from the air even though a centrifugal force is applied to the air having passed through the vane 200.

However, in an embodiment of the present disclosure, the air having passed through the vane 200 comes into contact with the droplet agglomeration guide 300 provided at the downstream side of the vane 200. Therefore, it is possible to obtain an advantageous effect of more effectively agglomerating the droplets contained in the air. In particular, the droplet agglomeration guide 300 may agglomerate the droplets with fine sizes (specific gravity) that are not separated by the centrifugal force applied by the vane 200.

In this case, the configuration in which the droplets agglomerated may be defined as a configuration in which the adjacent droplets are merged to define a single large droplet mass.

The droplet agglomeration guide 300 may have various structures capable of guiding the agglomeration of the droplets contained in the air while coming into contact with the air having passed through the vane 200. The present disclosure is not restricted or limited by the structure and shape of the droplet agglomeration guide 300.

According to an exemplary embodiment of the present disclosure, the droplet agglomeration guide 300 may be provided to have a cross-sectional area that gradually increases from one end, which is adjacent to the vane 200, toward the other end. An inclined guide portion 310 may be defined on a peripheral surface of the droplet agglomeration guide 300 and guide the droplets toward the inner peripheral surface of the housing member 100.

For example, the droplet agglomeration guide 300 may have an approximately conical (circular cone) shape having a circular cross-section that gradually enlarges from one end toward the other end.

In particular, a tip of the droplet agglomeration guide 300 (one end of the droplet agglomeration guide based on the axial direction of the vane), which faces the vane 200, may be disposed coaxially with the rotation center of the vane 200.

The inclined guide portion 310 may be variously changed in angle in accordance with required conditions and design specifications. The present disclosure is not restricted or limited by the angle of the inclined guide portion 310.

According to an exemplary embodiment of the present disclosure, an angle A1 of the inclined guide portion 310 may be relatively larger than an angle A2 of the tip of the guide member 400 (one end of the guide member adjacent to the droplet agglomeration guide) based on the axis of the vane 200 (A1>A2).

Because the angle A1 of the inclined guide portion 310 is relatively larger than the angle A2 of the tip of the guide member 400 as described above, it is possible to obtain an advantageous effect of minimizing a degree to which the droplets repelled from the droplet agglomeration guide 300 are attached to the outer surface of the guide member 400.

According to an exemplary embodiment of the present disclosure, the gas-liquid separator 10 may include a recessed portion 320 positioned at a downstream side of the inclined guide portion 310 and recessed in the droplet agglomeration guide 300.

As described above, the recessed portion 320 with an empty space shape is provided at the downstream side of the inclined guide portion 310, such that the pressure of the air passing through the recessed portion 320 (passing between the droplet agglomeration guide and the guide member) may increase. Therefore, it is possible to obtain an advantageous effect of minimizing an increase in differential pressure of the gas-liquid separator 10.

The recessed portion 320 may have various structures and shapes in accordance with required conditions and design specifications. The present disclosure is not restricted or limited by the structure and shape of the recessed portion 320.

For example, the recessed portion 320 may be provided in a continuous ring shape in the circumferential direction of the droplet agglomeration guide 300 so as to have an approximately triangular cross-sectional shape. According to another embodiment of the present disclosure, the recessed portion may have a quadrangular shape or other cross-sectional shapes. Alternatively, a plurality of recessed portions may be provided to be spaced apart from one another in the circumferential direction of the droplet agglomeration guide 300.

Meanwhile, in an embodiment of the present disclosure illustrated and described above, an example is described in which the peripheral surface of the droplet agglomeration guide 300 has a smooth flat shape. However, according to another embodiment of the present disclosure, stepped portions 330 may be provided on the peripheral surface of the droplet agglomeration guide 300.

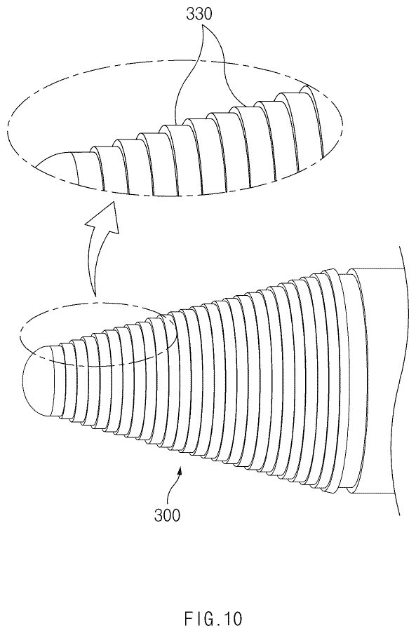

With reference to FIG. 10, according to an exemplary embodiment of the present disclosure, the gas-liquid separator 10 may include the stepped portions 330 provided on the peripheral surface of the droplet agglomeration guide 300.

The stepped portions 330 may have various structures capable of forming stepped projections on the peripheral surface of the droplet agglomeration guide 300. The present disclosure is not restricted or limited by the structure and shape of the stepped portions 330.

For example, the stepped portions 330 may be provided to define continuous step shapes in the longitudinal direction of the droplet agglomeration guide 300.

As described above, in an embodiment of the present disclosure, the stepped portions 330 are provided on the peripheral surface of the droplet agglomeration guide 300, such that a contact area of the droplet agglomeration guide 300 with which the droplets come into contact may be increased, and the time for which the droplets stay on the peripheral surface of the droplet agglomeration guide 300 may be increased. Therefore, it is possible to obtain an advantageous effect of improving the efficiency in agglomerating the droplets.

With reference to FIGS. 1, 2, and 11, the guide member 400 is provided in the housing member 100 and positioned at the downstream side of the droplet agglomeration guide 300 and defines the air discharge flow path 402 configured to guide the air, which is separated from the droplets, to the discharge port 104, and the droplet discharge flow path 404 configured to guide the droplets to the drain port 106.

The guide member 400 may have various structures capable of defining the air discharge flow path 402 and the droplet discharge flow path 404. The present disclosure is not restricted or limited by the structure and shape of the guide member 400.

According to an exemplary embodiment of the present disclosure, the guide member 400 may include a body portion 410 configured to separate the air discharge flow path 402 and the droplet discharge flow path 404, and air guide portions 420 provided in the body portion 410 and configured to guide the air, which is separated from the droplets in the droplet discharge flow path 404, to the air discharge flow path 402.

For example, the body portion 410 may have an approximately cylindrical hollow (drum) shape. According to another embodiment of the present disclosure, the body portion may have a quadrangular cross-section or other cross-sectional shapes.

The air guide portion 420 may have various structures capable of guiding the air, which is introduced into the droplet discharge flow path 404, to the air discharge flow path 402. The present disclosure is not restricted or limited by the structure and shape of the air guide portion 420.

For example, the air guide portions 420 may be provided to define a continuous spiral shape in the circumferential direction of the body portion 410.

According to an exemplary embodiment of the present disclosure, the body portion 410 may be provided by spirally winding base members 412, which each have an approximate band shape, so that the base members 412 partially overlap one another. The air guide portions 420 may be defined along gaps between the adjacent base members 412 (gaps between the base members that overlap one another).

In particular, a total area defined by the inlets of the air guide portions 420 (a total sum of inlet areas of the air guide portions) may be larger than a cross-sectional area of the vane frame 210 in order to minimize an increase in differential pressure caused by the air guide portions 420.

As described above, in an embodiment of the present disclosure, the base members 412 are wound in a spiral shape, such that a separate process (e.g., a machining process) for forming the air guide portions 420 does not need to be performed. Therefore, it is possible to obtain an advantageous effect of simplifying the structure of the body portion 410, simplifying the process of manufacturing the body portion 410, and reducing costs.

In an embodiment of the present disclosure illustrated and described above, the example has been described in which the air guide portions 420 are configured to define a continuous spiral shape. However, according to another embodiment of the present disclosure, a plurality of air guide portions may be provided in the body portion and spaced apart from one another in the circumferential direction.

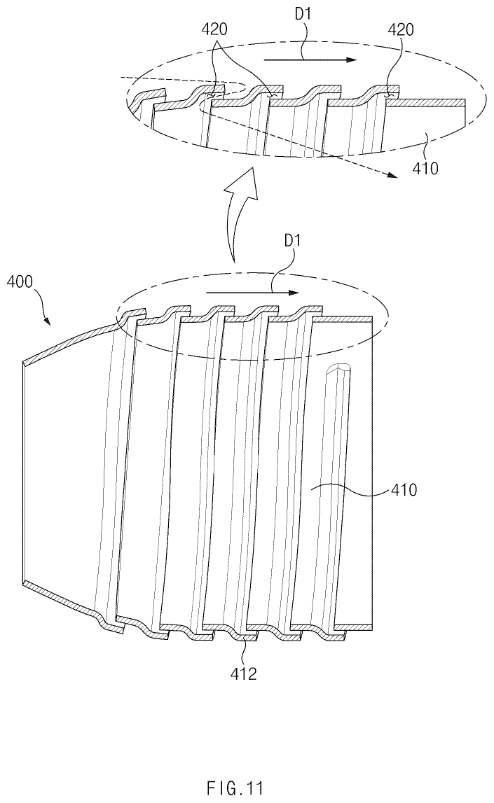

According to an exemplary embodiment of the present disclosure, the air guide portion 420 may be defined to have an inlet in a direction opposite to a movement direction D1 of the air from the vane 200 toward the guide member 400 (a direction from the left side toward the right side based on FIG. 11).

This is based on the fact that when the air moves in the direction D1 from the vane 200 toward the guide member 400 (the direction from the left side toward the right side based on FIG. 11), the droplets contained in the air also move in the direction D1 from the vane 200 toward the guide member 400. Because the inlets of the air guide portions 420 are provided in the direction opposite to the movement direction D1 of the air (the direction from the right side toward the left side based on FIG. 11), the droplets may remain in the droplet discharge flow path 404 (move in the direction from the vane toward the guide member), and only the air, which is lighter in weight than the droplets, may be introduced into the air guide portions 420 while changing the direction. Therefore, it is possible to obtain an advantageous effect of minimizing a degree to which the droplets are introduced into the air discharge flow path 402 through the air guide portions 420.

In an embodiment of the present disclosure illustrated and described above, the example has been described in which the inlet of the air guide portion 420 is defined in the direction opposite to the movement direction D1 of the air from the vane 200 toward the guide member 400. However, according to another embodiment of the present disclosure, an inlet of an air guide portion 420′ may be provided in a direction opposite to a rotation direction RD1 of the air.

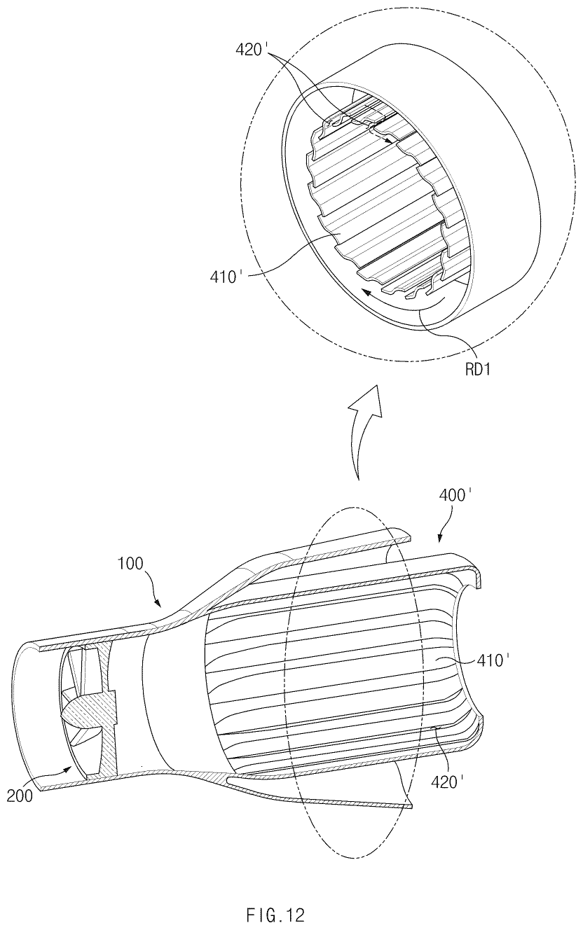

With reference to FIG. 12, a guide member 400′ includes a body portion 410′ and the air guide portions 420′, and the air guide portion 420′ may be defined to have an inlet in the direction opposite to the rotation direction RD1 of the air corresponding to the circumferential direction of the housing member 100.

This is based on the fact that when the air is rotated in the preset rotation direction RD1 (e.g., clockwise based on FIG. 12) by the vane 200, the droplets contained in the air are also rotated in the preset rotation direction RD1. Because the inlets of the air guide portions 420′ are provided in the direction (a counterclockwise direction based on FIG. 12) opposite to the rotation direction RD1 of the air, the droplets may remain in the droplet discharge flow path 404 (rotate clockwise based on FIG. 12), and only the air, which is lighter in weight than the droplets, may be introduced into the air guide portion 420′ while changing the direction. Therefore, it is possible to obtain an advantageous effect of minimizing a degree to which the droplets are introduced into the air discharge flow path 402 through the air guide portion 420′.

The air guide portion 420′ may have various structures having the inlet provided in the direction opposite to the rotation direction of the air. The present disclosure is not restricted or limited by the structure of the air guide portion 420′.

For example, the air guide portion 420′ may be provided to define a continuous slot shape in the longitudinal direction of the body portion 410′. According to another embodiment of the present disclosure, a plurality of air guide portions may be formed in the body portion and spaced apart from one another in the longitudinal direction.

In particular, a total area defined by the inlets of the air guide portions (a total sum of inlet areas of the air guide portions) may be larger than a cross-sectional area of the vane frame 210 in order to minimize an increase in differential pressure caused by the air guide portions 420′.

According to an exemplary embodiment of the present disclosure, the gas-liquid separator 10 may include an on-off valve 600 configured to selectively open or close the drain port 106.

The on-off valve 600 may be configured to inhibit outside contaminants or rainwater from reversely flowing into the drain port 106 under a traveling environment.

An active valve configured to periodically open or close the drain port 106 at a preset cycle may be used as the on-off valve 600, or a passive valve may be used as the on-off valve 600. The present disclosure is not restricted or limited by the type and structure of the on-off valve 600.

According to the embodiments of the present disclosure described above, it is possible to obtain an advantageous effect of improving the performance in capturing the droplets contained in the air discharged from the fuel cell stack.

In particular, according to the embodiments of the present disclosure, the droplets may be separated from the air and the droplets may be agglomerated by the centrifugal force made by the vortex of the air. Therefore, it is possible to obtain an advantageous effect of improving the efficiency in capturing the droplets.

In addition, according to the embodiments of the present disclosure, it is possible to obtain an advantageous effect of minimizing a deterioration in energy efficiency caused by an increase in differential pressure of the gas-liquid separator while miniaturizing the gas-liquid separator.

In addition, according to the embodiments of the present disclosure, it is possible to obtain an advantageous effect of simplifying the structure and improving the degree of design freedom and spatial utilization.

In addition, according to the embodiments of the present disclosure, it is possible to obtain an advantageous effect of minimizing a situation in which the droplets and the air are mixed again and improving the efficiency in separating the droplets.

While the embodiments have been described above, the embodiments are just illustrative and are not intended to limit the present disclosure. It can be appreciated by those skilled in the art that various modifications and applications, which are not described above, may be made to the present embodiments without departing from the intrinsic features of the present embodiments. For example, the respective constituent elements specifically described in the embodiments may be modified and then carried out. Further, it should be interpreted that the differences related to the modifications and applications are included in the scope of the present disclosure defined by the appended claims.

What is claimed is:

1. A gas-liquid separator comprising:
a housing member comprising an inlet port through which air is introduced, a discharge port through which the air is discharged, and a drain port through which droplets separated from the air are discharged;
a vane rotatably disposed in the housing member and configured to generate a vortex in the air introduced into the inlet port;
a droplet agglomeration guide disposed at a downstream side of the vane and configured to come into contact with the air having passed through the vane, the droplet agglomeration guide being configured to guide agglomeration of the droplets contained in the air; and
a guide member disposed in the housing member and positioned at a downstream side of the droplet agglomeration guide, the guide member defining an air discharge flow path configured to guide the air, which is separated from the droplets, to the discharge port, and a droplet discharge flow path configured to guide the droplets separated from the air to the drain port.

2. The gas-liquid separator of claim 1, wherein the housing member comprises:
a first housing comprising the inlet port; and
a second housing comprising the discharge port and the drain port, wherein the first housing and the second housing collectively surround a periphery of the guide member.

3. The gas-liquid separator of claim 2, wherein the first housing comprises:
an inlet portion comprising the inlet port and having a first cross-sectional area; and
an enlarged portion connected to a downstream side of the inlet portion and having a second cross-sectional area larger than the first cross-sectional area.

4. The gas-liquid separator of claim 3, wherein a cross-sectional area of the enlarged portion gradually increases from a first end that is adjacent to the inlet portion toward a second end.

5. The gas-liquid separator of claim 3, wherein:
the inlet portion has a straight length that is one or more times an outer diameter of the vane; and
the enlarged portion has a diameter smaller than 2.5 times the outer diameter of the vane.

6. The gas-liquid separator of claim 2, further comprising:
a first droplet guide groove disposed in a bottom portion of the first housing; and
a second droplet guide groove disposed in a bottom portion of the second housing, wherein a first end of the second droplet guide groove communicates with the first droplet guide groove and a second end of the second droplet guide groove communicates with the drain port.

7. The gas-liquid separator of claim 6, wherein the first droplet guide groove is spaced apart from the vane at a distance of one or more times an outer diameter of the vane.

8. The gas-liquid separator of claim 2, further comprising a filter member disposed in the guide member and surrounding a periphery of the air discharge flow path, the filter member being configured to capture the droplets.

9. The gas-liquid separator of claim 8, wherein the second housing comprises:
an outer housing part; and
an inner housing part spaced apart from an inner peripheral surface of the outer housing part and configured to support the filter member.

10. The gas-liquid separator of claim 9, wherein:
the inner housing part comprises:
an inner frame member having an end supported on the outer housing part; and
an outer frame member surrounding a periphery of the inner frame member and having an end supported on the outer housing part; and
the filter member is accommodated between the inner frame member and the outer frame member.

11. The gas-liquid separator of claim 10, further comprising:
a first through portion disposed in the inner frame member and in which the droplets fall downward in a gravitational direction; and
a second through portion disposed in the outer frame member, communicating with the first through portion, and in which the droplets fall downward in the gravitational direction.

12. The gas-liquid separator of claim 2, further comprising a valve seating part disposed at an end of the second housing and communicating with an outlet of the discharge port, wherein the valve seating part is inclined at a preset reference angle with respect to a vertical line.

13. The gas-liquid separator of claim 1, wherein the vane comprises:
a vane frame disposed in the inlet port;
inner blades disposed in the vane frame in a circumferential direction of the vane frame; and
outer blades continuously connected to the inner blades and protruding from an end of the vane frame that faces the droplet agglomeration guide.

14. A gas-liquid separator comprising:
a housing member comprising an inlet port through which air is introduced, a discharge port through which the air is discharged, and a drain port through which droplets separated from the air are discharged;
a vane rotatably disposed in the housing member and configured to generate a vortex in the air introduced into the inlet port;
a droplet agglomeration guide disposed at a downstream side of the vane and configured to come into contact with the air having passed through the vane, the droplet agglomeration guide being configured to guide agglomeration of the droplets contained in the air, wherein the droplet agglomeration guide has a cross-sectional area that gradually increases from an end that is adjacent to the vane toward a second end, and wherein an inclined guide portion is defined on a peripheral surface of the droplet agglomeration guide and is configured to guide the droplets toward an inner peripheral surface of the housing member; and
a guide member disposed in the housing member and positioned at a downstream side of the droplet agglomeration guide, the guide member defining an air discharge flow path configured to guide the air, which is separated from the droplets, to the discharge port, and a droplet discharge flow path configured to guide the droplets separated from the air to the drain port.

15. The gas-liquid separator of claim 14, further comprising a recessed portion recessed in the droplet agglomeration guide and positioned at a downstream side of the inclined guide portion.

16. The gas-liquid separator of claim 14, further comprising a stepped portion disposed on the peripheral surface of the droplet agglomeration guide.

17. A gas-liquid separator comprising:
a housing member comprising an inlet port through which air is introduced, a discharge port through which the air is discharged, and a drain port through which droplets separated from the air are discharged;
a vane rotatably disposed in the housing member and configured to generate a vortex in the air introduced into the inlet port;
a droplet agglomeration guide disposed at a downstream side of the vane and configured to come into contact with the air having passed through the vane, the droplet agglomeration guide being configured to guide agglomeration of the droplets contained in the air; and
a guide member disposed in the housing member and positioned at a downstream side of the droplet agglomeration guide, wherein the guide member defines an air discharge flow path configured to guide the air, which is separated from the droplets, to the discharge port, and a droplet discharge flow path configured to guide the droplets separated from the air to the drain port, and wherein the guide member comprises:
a body portion configured to separate the air discharge flow path and the droplet discharge flow path; and
an air guide portion disposed in the body portion and configured to guide the air, which is separated from the droplets in the droplet discharge flow path, to the air discharge flow path.

18. The gas-liquid separator of claim 17, wherein the air guide portion comprises an inlet in a direction opposite to a movement direction of the air from the vane toward the guide member.

19. The gas-liquid separator of claim 17, wherein:
the body portion comprises spirally winding base members in which the base members partially overlap one another; and
the air guide portion is defined along a gap between the adjacent base members.

20. The gas-liquid separator of claim 17, wherein the air guide portion comprises an inlet in a direction opposite to a rotation direction of the air corresponding to a circumferential direction of the housing member.
